(19) United States
(12) Patent Application Publication
(10) Pub. No.: US 2021/0375147 A1
(43) Pub. Date: Dec. 2, 2021

(54) METHOD AND SYSTEM FOR DETECTING AND AVOIDING OBSTACLES WITH SEVERAL DETECTION SPACES FOR AIRCRAFT

(71) Applicant: AIRBUS HELICOPTERS, Marignane (FR)

(72) Inventor: Lionel THOMASSEY, Fos Sur Mer (FR)

(73) Assignee: AIRBUS HELICOPTERS, Marignane (FR)

(21) Appl. No.: 17/325,415

(22) Filed: May 20, 2021

(30) Foreign Application Priority Data
May 28, 2020 (FR) 2005646

(51) Int. Cl. G08G 5/04; G08G 5/00; G06Q 10/04

(52) U.S. Cl. CPC G08G 5/045; G06Q 10/047; G08G 5/006

(57) ABSTRACT

A method and a system for detecting and avoiding obstacles with several obstacle detection spaces for an aircraft. The aircraft comprises a control system, a plurality of sensors for detecting obstacles in three detection spaces and a calculator. The method comprises a step of detecting at least one obstacle present in at least one detection space, a step of analyzing the at least one detected obstacle in order to determine at least one characteristic of the at least one obstacle, a step of determining at least one avoidance trajectory enabling the aircraft to avoid the at least one detected obstacle depending on at least one characteristic of the obstacle and a step of controlling the control system in order for the aircraft to automatically undertake an avoidance trajectory to avoid the detected obstacle.

### CROSS REFERENCE TO RELATED APPLICATIONS

This application claims priority to French patent application No. FR 20 05646 filed on May 28, 2020, the disclosure of which is incorporated in its entirety by reference herein.

### TECHNICAL FIELD

The present disclosure lies in the general technical field of aircraft piloting aids and, in particular, the field of obstacle detection and avoidance.

The present disclosure relates to a method and a system for detecting and avoiding obstacles with several detection spaces, as well as to an aircraft provided with such a system.

The present disclosure is intended for any type of aircraft, both aircraft with an onboard pilot and aircraft without an onboard pilot. An aircraft without an onboard pilot may be referred to as a “drone”, regardless of its dimensions.

### BACKGROUND

An obstacle may be stationary or mobile. A stationary obstacle is formed, for example, by the terrain surrounding the aircraft, a building, a tree or indeed a vehicle that is stationary with respect to the ground, such as another aircraft in hovering flight. A mobile obstacle is formed, for example, by a bird or indeed a vehicle that is moving relative to the ground, such as another aircraft in forward flight.

In order to take into account a possible obstacle, an aircraft may be equipped with an obstacle detection system. An obstacle detection system for an aircraft is, for example, known as an OWS (Obstacle Warning System). Another system, known as a GPWS (Ground Proximity Warning System), alerts the pilot of an aircraft only to the proximity of the ground.

An aircraft may also be equipped with a terrain avoidance piloting assistance system known as a TAWS (Terrain Avoidance Warning System). A TAWS makes it possible to detect the approach of dangerous obstacles and the topography situated in front of the trajectory of the aircraft.

Furthermore, warning systems for avoiding specific terrain and adapted to rotorcraft capable of operating at very low altitude are known as HTAWS (Helicopter Terrain Avoidance Warning Systems).

Such systems thus make it possible to automatically produce alerts depending on databases of the topography and any obstacles overflown. Furthermore, such a system may possibly establish an avoidance trajectory when the trajectory of the aircraft interferes with the topography or indeed an obstacle.

Systems combining obstacle detection and the automation of an avoidance maneuver can also be fitted to aircraft and are known as “Sense and Avoid Systems”.

For example, document FR 3 070 527 describes a method and a system for detecting and avoiding an obstacle. After detecting an obstacle in the environment of an aircraft, and its approach, the trajectories of the obstacle and of the aircraft are estimated, and a minimum distance separating these two trajectories is then calculated. An alarm is triggered as soon as this minimum distance drops below a first threshold in order to signal a risk of collision. If the minimum distance is less than a second threshold lower than the first threshold, an avoidance maneuver is performed automatically, i.e., without the intervention of a human pilot.

An obstacle detection system may comprise different types of sensors, for example an electromagnetic, optical or acoustic detector, possibly using ultrasound.

For example, an obstacle detection system may include a sensor using a light beam, known as LIDAR (LIght Detection And Ranging) or as LEDDAR (LED Detection And Ranging).

An obstacle detection system may include a sensor using electromagnetic or radio waves and known as RADAR.

An obstacle detection system may also comprise an imaging system consisting of a calculator and of at least one camera allowing an image or a series of images of the environment of the aircraft to be acquired. These images are analyzed, using existing and known techniques, in order to detect the presence of a possible obstacle in the environment of the aircraft and to estimate, for example, its position and speed relative to the aircraft.

Furthermore, the use of drones is becoming more widespread. The number of drones in flight is therefore rapidly increasing. Consequently, the risk of collision between two drones or between a drone and an aircraft is also increasing. However, drones may be equipped with devices for detecting obstacles, and indeed for automatically avoiding such obstacles.

For example, document CN 105629985 describes an obstacle detection and avoidance device for a four-rotor drone. This four-rotor drone includes a plurality of ultrasonic sensors distributed substantially uniformly around the drone in order to detect obstacles in a three-dimensional environment and measure the distance between the drone and each obstacle. These distance measurements are processed by a Kalman filter and merged, and a decision to avoid the detected obstacle is then optionally taken by means of a fuzzy logic algorithm.

According to this document CN 105629985, the decision that is taken and its consequences differ according to the detection space in which this obstacle is located, and in particular depending on the distance between the detected obstacle and the drone. For example, in the case of a distant obstacle, no maneuver is carried out, and the flight of the drone remains unchanged. In the case of an obstacle situated at an intermediate distance, the flight speed of the drone may be reduced, while in the case of a nearby obstacle, the drone carries out a maneuver to actually avoid the obstacle with a change of heading.

Document WO 2018/129321 discloses a system for automatically detecting and avoiding stationary and/or moving obstacles for a drone. Such a system comprises a plurality of sensors, for example acoustic, optical and/or RADAR sensors. This system also uses three detection regions in order to adapt the maneuver to be performed depending on the detection region in which an obstacle is detected.

Document WO 2020/040773 describes a four-rotor drone comprising a calculator and an obstacle detection device. The detection device comprises a detection sensor for obtaining a 360° image around the drone and, after analysis of the image by a calculator, detecting the distance and the direction of an obstacle. The detection sensor may scan zones of different widths or indeed a circular zone around the drone. The calculator makes it possible, following the detection of an obstacle, to determine, if necessary, one or more avoidance paths to avoid the detected obstacle, and to assign weightings to them.

Document US 2010/0292871 describes a method and a system for monitoring and guiding aircraft intended, in particular, to avoid collisions in flight. This system may comprise an on-board sensor of different types, for example a radar altimeter, a laser rangefinder, an active electronic scanning radar system, a laser, an electro-optical or infrared imager or other type of sensor capable of detecting and locating stationary or mobile obstacles. This system also includes a calculator and an automatic control device as well as a data communication device for detecting an obstacle and receiving information relating to its speed and trajectory. This monitoring and guidance system can use three detection zones or thresholds defined by distances or indeed a time before a potential collision. When an obstacle is detected in one of the detection zones, an avoidance maneuver is performed, this maneuver being defined as a function of the detection zone in which the detected obstacle is located.

### SUMMARY

An object of the present disclosure is therefore to propose a method and a system for detecting and avoiding obstacles aimed at overcoming the above-mentioned limitations, by optimizing and making reliable the detection of obstacles in several detection spaces and by adapting the avoidance maneuver as a function of the trajectory of the detected obstacle, or indeed its nature.

An object of the present disclosure is therefore first and foremost a method for detecting and avoiding obstacles with several obstacle detection spaces for an aircraft. This aircraft includes, for example:

an aircraft control system;

a plurality of sensors for detecting obstacles, the plurality of sensors comprising at least three series of sensors; and

at least one calculator.

The method for detecting and avoiding obstacles with several obstacle detection spaces for an aircraft according to the disclosure comprises the following steps:

detecting at least one obstacle present in at least one of these at least three detection spaces, said at least three detection spaces comprising a first detection space, a second detection space and at least one third detection space, the first detection space being the detection space closest to the aircraft, the second detection space being the detection space furthest from the aircraft, each of said at least three series of sensors being associated with at least one of the detection spaces, each detection space being covered by at least one series of sensors;

analyzing at least one obstacle detected in at least one of the detection spaces by means of the calculator in order to determine at least one characteristic of said at least one obstacle;

determining at least one avoidance trajectory or avoidance command enabling the aircraft to avoid each detected obstacle depending on at least one characteristic of said obstacle by means of the calculator; and

controlling the control system so that the aircraft automatically undertakes an avoidance trajectory or an avoidance command.

In this way, the method according to the disclosure makes it possible to detect a risk of collision between the aircraft and an obstacle over all of the detection spaces and to propose an avoidance maneuver in the presence of an obstacle and a risk of collision. This avoidance maneuver may consist, for example, of a new trajectory to be followed by the aircraft, referred to as an “avoidance trajectory”, or else an avoidance command.

The avoidance trajectory may comprise, for example, a new course bypassing one or more detected obstacles and connecting to the initial course towards the initial objective or indeed a new course bypassing one or more detected obstacles and safely reaching the initial objective directly.

An avoidance command may comprise, for example, a change in the forward speed of the aircraft, a change in the acceleration of the aircraft or indeed a change in the load factor of the aircraft while remaining on the course initially provided towards the initial objective. This change in forward speed, acceleration or load factor enables the aircraft, though moving along the initial course towards the initial objective, to avoid colliding with a detected object or avoid passing in the vicinity of each detected object.

The aircraft may be an aircraft comprising an onboard pilot or indeed an aircraft without an onboard pilot. An aircraft without an onboard pilot may be controlled remotely by a human pilot or may indeed be piloted automatically or autonomously.

In all cases, this aircraft may be a rotorcraft provided with one or more rotary wings or indeed an aircraft with at least one fixed wing.

In addition, the dimensions of the aircraft may vary very considerably in the case of an aircraft without an onboard pilot, ranging, for example, from approximately ten centimeters to several meters.

A detected obstacle may be stationary or mobile relative to a landmark. A stationary obstacle is, for example, a wall, a building, a pylon, the topography of the ground or indeed an aircraft in hovering flight. A mobile obstacle may be a bird or another aircraft moving relative to the ground. Such an aircraft may be of very small dimensions or an aircraft of larger dimensions, for example.

A mobile obstacle may also be a leaf flying in the air or a balloon, for example, for an aircraft of small size, flying at very low altitude or being close to the ground during a landing phase.

The detection of at least one obstacle in at least one of the detection spaces is carried out by means of the plurality of sensors which the aircraft comprises. The plurality of sensors may include optical, acoustic, and/or electromagnetic obstacle detectors.

The plurality of sensors preferably comprises as many series of sensors as there are detection spaces used by the method according to the disclosure. Advantageously, said at least three series of sensors together cover said at least three detection spaces.

Consequently, each series of sensors may be dedicated to a single detection space and therefore covers a specific detection space in the environment of the aircraft. In this case, each series of sensors may advantageously be adapted to the detection space that it covers in order, in particular, to have a detection range optimized for this detection space, making it possible to obtain the best efficiency and the best accuracy in terms of detecting an obstacle in each detection space. All the sensors of the same series of sensors may, for example, have the same detection range.

However, a series of sensors may also cover several detection spaces in the environment of the aircraft. Such a series of sensors is then adapted to the detection spaces that it covers. For example, such a series of sensors may include sensors capable of detecting obstacles in all the detection spaces covered by said series of sensors.

Alternatively, such a series of sensors may also include sensors capable of detecting in a single one of the detection spaces covered by the series of sensors. This series of sensors may, for example, comprise several sets of sensors, each set of sensors being adapted to and associated with a single detection space.

In addition, each series of sensors may include at least two different types of sensor technologies covering the same detection space. In this way, sensor dissimilarity and redundancy are assured in each series of sensors in order to be able to immediately overcome a possible failure of one or more sensors without limiting the detection space associated with a series of sensors, and therefore without having zones not covered by at least one sensor, and therefore not having any zone without detection.

Furthermore, the dimensions of each detection space are determined by the number of sensors included in the series of sensors associated with this detection space and their range as well as by the detection zone of each sensor of this series of sensors.

For example, each detection space may cover a zone of 360 degrees (360°) in a horizontal plane passing through the center of gravity of the aircraft and a zone of 360° in vertical planes passing through the center of gravity of the aircraft. A horizontal plane is, for example, a plane perpendicular to a vertical direction of the aircraft corresponding, for example, to its yaw axis. A vertical plane is, for example, a plane parallel to this vertical direction of the aircraft.

In this way, each detection space has a shape substantially comprised between two spheres situated around the aircraft and centered on the aircraft. These two spheres correspond respectively to the two limits of the minimum and maximum ranges of the sensors of the series of sensors associated with this detection space.

Each detection space may also cover a zone of 360 degrees (360°) in the horizontal plane passing through the center of gravity of the aircraft and a zone covering a sector of a few tens of degrees, for example, in vertical planes passing through the center of gravity of the aircraft.

Each detection space may also cover a zone of less than 360 degrees (360°) in a horizontal plane passing through the center of gravity of the aircraft and a zone covering a sector of a few tens of degrees in vertical planes passing through the center of gravity of the aircraft. In particular, a zone behind the aircraft may not be covered by a detection space.

In addition, a detection space may be situated beneath the aircraft, downwards, for example in order to detect, in particular, the ground and the obstacles situated on the ground.

In addition, each detection space may have a detection zone common to at least one other detection space. This common detection zone constitutes a zone in which these at least two detection spaces overlap. This overlap zone thus ensures spatial continuity of detection and a transition between the detection spaces and advantageously ensures no non-detection zones are present in the vicinity of the aircraft. In addition, this overlap zone is provided by cooperation between the series of sensors of the overlapping detection spaces. In this way, the method according to the disclosure makes it possible to detect a risk of collision in all the detection spaces continuously, in particular without a non-detection zone between the detection spaces.

For example, an overlap zone in which two adjacent detection spaces overlap may be formed by a portion of each of these two adjacent detection spaces, typically by a zone situated at the periphery of each of these two detection spaces. Said at least one third detection space thus covers a space located beyond the first detection space, said at least one third detection space being located between the first detection space and the second detection space.

According to another example, an overlap zone in which two detection spaces overlap may be one of these two detection spaces, thus ensuring detection redundancy in the common detection zone. Thus, when the method uses three detection spaces, the third detection space includes the first detection space and also covers a space situated beyond the first detection space while the second detection space includes the first detection space and the third detection space and also covers a space situated beyond the third detection space. These detection spaces are thus nested in the manner of Russian dolls.

The method according to the disclosure preferably uses three detection spaces in order to limit the detection zones covered while allowing the earliest possible detection of a potentially dangerous obstacle and the implementation of an optimum avoidance maneuver adapted to the danger represented by this detected obstacle.

Following the detection of at least one obstacle in one of said at least three detection spaces, the step of analyzing each detected obstacle is carried out depending on the information provided by the sensors. This analysis step allows the detected obstacle to be characterized.

The characteristics of an obstacle are, for example, its relative position with respect to the aircraft as well as its speed, its course and/or its heading with respect to the aircraft. The relative trajectory of each detected obstacle with respect to the aircraft can then be determined.

Another characteristic of an obstacle may be determined from the speed and distance of the detected obstacle relative to the aircraft, i.e., the time before a possible impact between the aircraft and the detected obstacle. This time before a possible impact can be referred to as TBI (Time Before Impact) and makes it possible to characterize the imminence of the danger associated with this obstacle.

The dimensions of the obstacle, its mass and the type of obstacle may also be estimated or determined as a function of the information provided by the sensors.

However, the information provided by the sensors may differ depending on the sensor technology. Their accuracy may also differ depending on the sensor technology and the distance between the obstacle and the aircraft. Consequently, the characteristics of an obstacle that can be determined can vary and depend on the technology of the sensor that has detected the obstacle and on the position of the obstacle and, in particular, on the distance between the obstacle and the aircraft, and therefore on the detection space in which the obstacle is detected.

Regardless of its technology and accuracy, a sensor makes it possible to determine, in a known manner, at least the position of a detected obstacle, and then, by processing the information provided, over a more or less long period of time, to estimate the speed and the course of the obstacle, and to deduce therefrom a relative trajectory of the obstacle with respect to the aircraft.

In addition, the dimensions of the detected obstacle and/or the type of obstacle can also be estimated, by analyzing the information provided by certain sensors.

For example, a RADAR sensor provides a radar cross-section (RCS) for each detected object whereas an optical sensor may provide an optical spot. The dimensions of a detected object may be estimated using the dimensions of the radar cross-section or optical spot provided correlated with the distance between the aircraft and the detected obstacle.

Furthermore, the type of obstacle to which the detected obstacle belongs may be determined, for example, by image processing of the radar cross-section or the optical spot provided or indeed by correlation between the radar cross-section or the optical spot provided and the dimensions and speed of the detected obstacle.

In addition, the type of obstacle detected can also be identified by analyzing the information provided by certain sensors. Such an analysis requires information specific to each type of obstacle provided by one or more sensors. For this purpose, the method according to the disclosure may implement a learning process referred to, for example, as “deep learning”. By virtue of a learning process carried out beforehand on a large number of known and potential types of obstacles, it is possible for the method according to the disclosure to detect, recognize and classify each detected obstacle depending on the information provided by the sensor that has detected it. This information may be the signature of this obstacle detected by the sensor or the signal returned by this obstacle and detected by the sensor or indeed at least one image recorded by a camera and analyzed by a pattern recognition method, for example.

The analysis step may then comprise a sub-step of identifying a type of obstacle to which said at least one detected obstacle may correspond, this identification step being carried out, for example, by means of a calculator.

Known types of stationary obstacles are, for example, a wall, a building, a tree, an aircraft in hovering flight, etc. Known types of mobile obstacles are, for example, a tree leaf, a balloon, a bird or indeed an aircraft in forward flight, such as a drone, a helicopter, an aircraft, etc.

Such a learning process enables the calculator to learn to detect and identify an obstacle, regardless of its shape and dimensions, from the many elements detected or indeed visible in the information provided by a sensor or in an image of the environment of the aircraft, in the event that a camera is used.

Furthermore, the information provided by a sensor can be processed either at the sensor itself, by a calculator integrated with the sensor, at a calculator external to the sensor, or indeed at both a calculator integrated with the sensor and a calculator external to the sensor. For example, the calculator external to the sensor may be embedded on the aircraft and receive the information from each sensor via wired or wireless links. The calculator external to the sensor may also be located outside the aircraft and receive the information from each sensor via wireless links.

Some sensors, in particular sensors with a long detection range, only make it possible to determine the position of the detected obstacle, and to then estimate a speed, heading, course and/or trajectory of the obstacle relative to the aircraft. This is the case of some RADAR sensors as well as some cameras for obstacles detected at distances far from the aircraft, for example from several hundred meters to several miles.

Other sensors, such as LEDDAR or LIDAR sensors, can almost instantaneously provide the position, speed, heading and/or course of the detected obstacle. Indeed, these sensors are very precise and incorporate a computing unit allowing the collected information to be processed directly and quickly. The relative trajectory of the obstacle with respect to the aircraft can then be estimated by a calculator, for example embedded on the aircraft. The type of obstacle detected can be defined from the information provided by these sensors.

Cameras associated with methods for analyzing captured images and for pattern recognition implemented by a calculator, for example embedded on the aircraft, make it possible to determine the position, speed, heading and/or course of the detected obstacle, and to estimate its trajectory. However, these calculations may take a relatively long time depending on the calculators used and the quality of the captured images, in particular. The dimensions and the type of obstacle detected may also be defined during this analysis of the images provided by cameras.

Finally, ultrasound sensors and infrared sensors generally have short ranges and provide precise information for accurately determining the position, speed, heading and/or course of the aircraft and deducing therefrom the relative trajectory of the obstacle with respect to the aircraft. The dimensions and the type of obstacle detected may also be defined on the basis of the information provided by these sensors.

In addition, information provided by several sensors associated with the same detection space or indeed covering the overlap zone in which two detection spaces overlap may be combined and/or merged, in particular in order to advantageously improve the accuracy of the information concerning the obstacle, and, in particular, in order to determine the type of obstacle detected and the confidence associated with this determination. For example, the same type of obstacle may have two different signatures for two different sensor technologies, making it possible to identify this type of obstacle with a high confidence index, whereas two different types of obstacle may have two signatures that are close, or even similar, for one particular sensor technology, which then does not allow the type of obstacle in question to be identified with certainty.

After characterizing the detected obstacle in this way, the step of determining at least one avoidance trajectory or one avoidance command enabling the aircraft to avoid each detected obstacle is carried out. At least one avoidance trajectory or avoidance command can be determined only if a risk of collision is established, namely if the current trajectory of the aircraft interferes with or passes in the vicinity of the detected obstacle, if the obstacle is stationary, or indeed the estimated trajectory of the obstacle, if the obstacle is mobile. The aircraft is considered to be passing in the vicinity of the detected obstacle or its trajectory if the minimum distance between the current trajectory of the aircraft and the detected obstacle or its estimated trajectory is less than a distance threshold. A distance threshold may depend on the size of the aircraft. For example, a distance threshold may lie between 10 meters and 100 meters. This risk of collision may be estimated, for example, during the analysis step. The analysis step may then comprise a sub-step of estimating a risk of the aircraft colliding with said at least one detected obstacle, this step of estimating a risk of collision being carried out, for example, by means of a calculator.

Each avoidance trajectory or each avoidance command determined during this step takes into account the flight limits of the aircraft ensuring the comfort of the passengers who may be transported and/or the force limits acceptable to the payload transported by the aircraft so as not to degrade this payload.

Each avoidance trajectory or each avoidance command is also determined by taking into account the determined or estimated characteristics of each detected obstacle in order for the aircraft to avoid each detected obstacle and reach its initial objective. Each avoidance trajectory or each avoidance command is determined in order to avoid each detected obstacle while limiting the stresses experienced by an aircraft flying along these trajectories, in order to ensure the comfort of the passengers of the aircraft or indeed the integrity of the transported payload, and/or while complying with one or more criteria such as limiting the energy consumption of the aircraft or the travel time, and adhering to a corridor around the current trajectory of the aircraft making it possible to reach the initial objective of the flight while limiting excursions out of this corridor in time and in space to what is necessary.

In particular, each avoidance trajectory or each avoidance command can advantageously be determined so as to minimize changes in the trajectory or control of the aircraft in order, for example, to limit the in-flight stresses experienced by the aircraft and its payload, limit energy consumption and adhere as closely as possible to the initial trajectory by minimizing excursions from this initial trajectory in time and in space.

Each avoidance trajectory or each avoidance command can be determined in a known manner by using one or more appropriate algorithms and by applying the characteristics mentioned above, as well as one or more of these criteria and/or constraints. For example, each avoidance trajectory or each avoidance command may be determined by applying the teaching of document FR 3 070 527.

A single avoidance trajectory or a single avoidance command may be determined during the determination step. This single avoidance trajectory or this single avoidance command is determined by taking into account the characteristics mentioned above, as well as one or more of these criteria and/or constraints in order for the aircraft to avoid each detected obstacle and reach its initial objective. This single avoidance trajectory is, for example, the only avoidance trajectory satisfying all of these characteristics, constraints and criteria. Similarly, this single avoidance command is, for example, the only avoidance command satisfying all of these characteristics, constraints and criteria.

Then, during the step of controlling the aircraft control system by means of the calculator, for example, the calculator transmits the characteristics of this avoidance trajectory or this avoidance command to the aircraft control system in order for the aircraft to automatically undertake the avoidance trajectory or the avoidance command so as to avoid each detected obstacle.

An avoidance trajectory may include a deviation from a current trajectory of the aircraft and a return to this current trajectory enabling it to avoid an obstacle and reach its initial objective. An avoidance trajectory may also consist of a new trajectory replacing the current trajectory of the aircraft in order to avoid one or more obstacles and safely reach its initial objective.

Furthermore, at least two avoidance trajectories or at least two avoidance commands can also be determined during the step of determining at least one avoidance trajectory or one avoidance command. Each of these avoidance trajectories or avoidance commands makes it possible to avoid each detected obstacle while complying with the characteristics mentioned above, as well as one or more of these criteria and/or these constraints.

In this case, the method according to the disclosure may comprise an additional step of choosing an effective avoidance trajectory or an effective avoidance command from said at least two determined avoidance trajectories or said at least two determined avoidance commands, respectively. During the step of choosing, an effective avoidance trajectory or an effective avoidance command is chosen respectively from said at least two determined avoidance trajectories or said at least two determined avoidance commands by minimizing, for example, one or more criteria chosen from the energy consumption of the aircraft, the flight time along the avoidance trajectory, the distance travelled along the avoidance trajectory, etc.

An effective avoidance trajectory or an effective avoidance command can also be chosen such that, for example, a minimum distance between the course of a detected obstacle and the trajectory of the aircraft is greater than a threshold.

In this case, the step of controlling the aircraft control system is carried out using the effective avoidance trajectory or the effective avoidance command chosen in order for the aircraft to automatically undertake the avoidance trajectory or the avoidance command so as to avoid each detected obstacle.

Moreover, when several avoidance trajectories or several avoidance commands are determined during the step of determining at least one avoidance trajectory or one avoidance command, these avoidance trajectories or avoidance commands can be grouped together to form a “particle swarm” of trajectories. An algorithm using a particle swarm can be used to keep each trajectory of the aircraft associated respectively with an avoidance trajectory or an avoidance command, and therefore the aircraft, at reasonable distances from any obstacle.

Particle swarm optimization is inspired by biology and makes it possible to simultaneously establish several avoidance trajectories or several avoidance commands within the particle swarm. At each iteration, the avoidance trajectories or the avoidance commands move like a cloud towards areas that look more advantageous.

Furthermore, the use of several detection spaces makes it possible to detect an obstacle as early as possible, in particular when it enters the second detection space, i.e., the detection space the furthest from the aircraft. The method according to the disclosure therefore provides a considerable amount of time to analyze and identify the detected obstacle, in order in particular to define whether the aircraft has a possible risk of collision with this obstacle, and establish and undertake an avoidance trajectory or avoidance command to avoid this detected obstacle if this risk of collision is established.

Thus, if at least one obstacle is detected in the second detection space, the step of determining at least one avoidance trajectory or one avoidance command and the step of controlling the control system can be inhibited. Thus, as the risk of collision is remote in time and the trajectory of the detected obstacle may change, it is not necessary to immediately determine an avoidance trajectory or an avoidance command. The method may then comprise an additional step of monitoring said at least one detected obstacle.

However, the time before a possible impact, TBI, relative to this detected obstacle may also be taken into account in order to inhibit these steps and possibly carry out an additional monitoring step. For example, if at least one obstacle is detected in the second detection space and the step of analyzing the detected obstacle determines a TBI greater than a first time threshold, the step of determining at least one avoidance trajectory or one avoidance command and the step of controlling the control system can be inhibited. The method may then comprise an additional step of monitoring said at least one detected obstacle. The first time threshold is, for example, equal to 10 seconds.

During this additional monitoring step, said at least one detected obstacle is monitored by means of at least one series of sensors, until it enters the third detection space or indeed until the TBI is less than or equal to the first time threshold.

Next, the step of analyzing the detected obstacle can be carried out regardless of the detection space in which an obstacle is detected and as soon as the detection of at least one obstacle and the information provided by a series of sensors allow this. Similarly, the steps of determining at least one avoidance trajectory or one avoidance command and of controlling the control system can be carried out as early as possible, regardless of the detection space in which an obstacle is detected. Thus, a maneuver to avoid the detected obstacle can be carried out as soon as possible after the obstacle is detected in order for this avoidance maneuver to be early and as smooth as possible so as to limit, in particular, the mechanical stresses on the aircraft or the physical stresses on any passengers and/or the transported payload.

Therefore, by anticipating as early as possible the determination of at least one avoidance trajectory or one avoidance command and the undertaking of an avoidance maneuver according to an avoidance trajectory or an avoidance command, the avoidance maneuver can advantageously be optimized in order to limit the energy consumption of the aircraft, and to not overreact to a detected obstacle, instead reacting appropriately only according to the real danger it poses. Moreover, the avoidance maneuver may also be optimized in order to minimize the forces experienced by the transported payload of this payload is fragile or sensitive.

Thus, when an obstacle is detected sufficiently early and the information provided by the sensors makes it possible to carry out the step of analyzing the detected obstacle, one or more smooth and progressive avoidance trajectories or one or more smooth and progressive avoidance commands may be determined during the step of determining at least one avoidance trajectory or one avoidance command, by minimizing, for example, changes in direction.

Conversely, when an obstacle is detected late, for example only in the first detection space, i.e., the detection space closest to the aircraft, or indeed the speed of the obstacle is very high and the TBI is very low, an emergency avoidance trajectory or an emergency avoidance command must be taken into account so as to allow the aircraft to react more quickly in order to move away from the detected object. This emergency avoidance maneuver may be sudden and generate major forces on the payload and/or the passengers transported in the aircraft, while complying with predetermined limitations.

For example, if an obstacle is detected in the first detection space, the step of analyzing the detected obstacle and the step of determining at least one avoidance trajectory or one avoidance command may be inhibited and an avoidance trajectory or an avoidance command is chosen respectively from predetermined emergency avoidance trajectories or predetermined emergency avoidance commands. Thus, the step of controlling the control system is carried out immediately in order for the emergency avoidance maneuver to be carried out quickly. These predetermined emergency avoidance trajectories or predetermined emergency avoidance commands may possibly be stored, for example, in the form of a database, in a memory connected to the calculator.

An obstacle may be detected in the first detection space following a change in the object trajectory, after the undertaking of an insufficient avoidance maneuver following the detection of this obstacle in the second and/or third detection space, or indeed following the non-detection of this object in the other detection spaces, for example due to a failure of some sensors covering the other detection spaces.

Similarly, if a TBI associated with a detected obstacle is determined to be very short, typically less than a second time threshold, during the analysis step, regardless of the detection space, the step of determining at least one avoidance trajectory or one avoidance command may be inhibited and an avoidance trajectory or an avoidance command is chosen respectively from the predetermined emergency avoidance trajectories or the predetermined emergency avoidance commands. Thus, the step of controlling the control system is carried out immediately in order for the emergency avoidance maneuver to be carried out quickly. The second time threshold is, for example, equal to 5 seconds.

Furthermore, weighting can be applied to each detected obstacle. This weighting may depend, in particular, on the detection space in which the obstacle is detected or indeed on the series of sensors that has detected the obstacle. The analysis step may comprise a sub-step of determining a weighting associated with each detected obstacle in order to determine a weighting associated with each detected obstacle.

This weighting may be determined depending on the detection space in which the obstacle has been detected or indeed depending on the series of sensors that has detected this obstacle. This weighting may possibly depend on the distance between the obstacle and the aircraft.

Indeed, an obstacle detected in the first detection space should be treated, a priori, with more attention than an obstacle detected in the second or third detection space. This weighting thus makes it possible, when several obstacles are detected simultaneously by several series of sensors, to merge the information provided by these series of sensors, applying different weightings to this information depending on the detection space associated with each series of sensors. The weighting coefficients may reduce, for example, when the distance between a detection space and the aircraft increases. In this case, the highest weighting coefficient is thus applied to the information provided by the series of sensors associated with the first detection space and the lowest weighting coefficient is thus applied to the information provided by the series of sensors associated with the second detection space. This weighting is thus applied to the information provided by each series of sensors for each detected obstacle in order to determine each avoidance trajectory or each avoidance command during the step of determining at least one avoidance trajectory or one avoidance command.

Moreover, this weighting associated with a detected obstacle may also take into account one or more characteristics of each detected obstacle. The weighting associated with a detected obstacle may be linked, in particular, to different characteristics of the obstacle such as:

the dimensions of the obstacle relative to that of the aircraft;

the mass and the speed of the obstacle;

the relative trajectory of the obstacle with respect to the aircraft; and

the time before a possible impact, TBI.

Other criteria related to the aircraft may also be taken into account in order to define the weighting associated with a detected obstacle, namely the maneuverability of the aircraft, its maximum achievable acceleration and speed, and its dimensions, impact resistance and structural strength.

This weighting associated with each detected obstacle may then be taken into account during the step of determining at least one avoidance trajectory or one avoidance command in order to determine at least one avoidance trajectory or one avoidance command.

For example, during the step of determining at least one avoidance trajectory or one avoidance command, an algorithm may simultaneously take into account each detected obstacle with its weighting and determine one or more avoidance trajectories or one or more avoidance commands to avoid each of these detected obstacles while complying with the characteristics mentioned above, as well as one or more of these criteria and/or constraints.

According to another example, an algorithm may define one or more intermediate avoidance trajectories or one or more intermediate avoidance commands independently for each detection space by taking into account each obstacle detected in this detection space, while complying with the characteristics mentioned above, as well as one or more of these criteria and/or constraints. A weighting relative to each detection space is then associated with each intermediate avoidance trajectory or with each intermediate avoidance command corresponding to a detection space.

Next, the intermediate avoidance trajectories or the intermediate avoidance commands relative to these detection spaces are combined, taking into account these weightings in order to determine at least one avoidance trajectory or one avoidance command.

According to another example, an algorithm may define one or more intermediate avoidance trajectories or one or more intermediate avoidance commands for each detected obstacle while complying with the characteristics mentioned above, as well as one or more of these criteria and/or constraints. The weighting relative to each detected obstacle is then associated with each intermediate avoidance trajectory or with each intermediate avoidance command corresponding to a detected obstacle. Thus, the obstacles closest to the aircraft can be taken into account with a higher weighting.

Next, the intermediate avoidance trajectories or the intermediate avoidance commands relative to these detected obstacles are combined, taking into account these weightings in order to determine at least one avoidance trajectory or one avoidance command. Thus, if two obstacles are detected in two different detection spaces, for example a first obstacle in the third detection space and a second obstacle in the second detection space, the second detected obstacle may, despite being further from the aircraft, have a higher weighting than the first obstacle, for example if the TBI is shorter for the second obstacle than for the first obstacle. The intermediate avoidance trajectory or the intermediate avoidance command relative to this second obstacle is therefore to be taken into account first when determining the avoidance trajectory or the avoidance command.

The present disclosure also relates to a system for detecting and avoiding obstacles with several obstacle detection spaces for an aircraft configured to implement the method described above. The system for detecting and avoiding obstacles comprises:

an aircraft control system;

a plurality of sensors for detecting obstacles; and

at least one calculator.

The plurality of sensors comprises at least three series of sensors, each series of sensors covering at least one detection space in the environment of the aircraft and each detection space being covered by at least one series of sensors. Moreover, each series of sensors may comprise several different sensor technologies covering the same detection space, typically two sensor technologies. Thus, each series of sensors is dissimilar and redundant in its detection space.

Moreover, in the event that the system for detecting and avoiding obstacles with several obstacle detection spaces comprises three series of sensors and covers three detection spaces arranged such that an overlap zone in which two detection spaces overlap is one of these two detection spaces, the coverage of the first detection space is advantageously threefold and dissimilar, because it is provided by three series of sensors comprising two different sensor technologies, and the coverage of the third detection space is twofold and dissimilar, because it is provided by two series of sensors comprising two different sensor technologies.

This means that the system according to the disclosure is robust to a single sensor failure in the three detection spaces and robust to a double failure in the first and third detection spaces.

Moreover, the system for detecting and avoiding obstacles with several obstacle detection spaces may be entirely embedded in the aircraft. A calculator of the system can then be dedicated to carrying out the method for detecting and avoiding obstacles with several obstacle detection spaces or indeed be shared with other functions of the aircraft and be integrated, for example, into an avionics system of the aircraft.

The system for detecting and avoiding obstacles with several obstacle detection spaces may also be arranged partially outside and remote from the aircraft. For example, the series of sensors and the control system may be embedded on the aircraft while said at least one calculator may be arranged in a control station outside the aircraft and remote from the aircraft. The control station is situated, for example, on the ground or indeed in another aircraft. In this case, the aircraft comprises a first communication device cooperating with a second communication device arranged in the control station and connected to a calculator of the system according to the disclosure in order to exchange the information collected by the sensors and the characteristics of the avoidance trajectory or the avoidance command to be undertaken.

The present disclosure also relates to an aircraft comprising such a detection system.

The present disclosure finally relates to an assembly for detecting and avoiding obstacles comprising the system for detecting and avoiding obstacles with several obstacle detection spaces and an aircraft. Said at least one calculator of the system according to the disclosure may be embedded in the aircraft or indeed remote, as described above, in a control station of the assembly for detecting and avoiding obstacles.

### BRIEF DESCRIPTION OF THE DRAWINGS

The disclosure and its advantages appear in greater detail from the following description of examples given by way of illustration with reference to the accompanying figures, in which:

FIG. 1 shows an aircraft comprising a system for detecting and avoiding obstacles;

FIG. 2 shows an aircraft without an onboard pilot comprising a system for detecting and avoiding obstacles;

FIG. 3 shows an assembly for detecting and avoiding obstacles;

FIGS. 4 and 5 show an aircraft and the detection spaces;

FIG. 6 shows membership domains according to a fuzzy logic method;

FIG. 7 shows a decision matrix associated with these membership domains; and

FIG. 8 shows obstacles detected in the detection spaces.

### DETAILED DESCRIPTION

Elements present in more than one of the figures are given the same references in each of them.

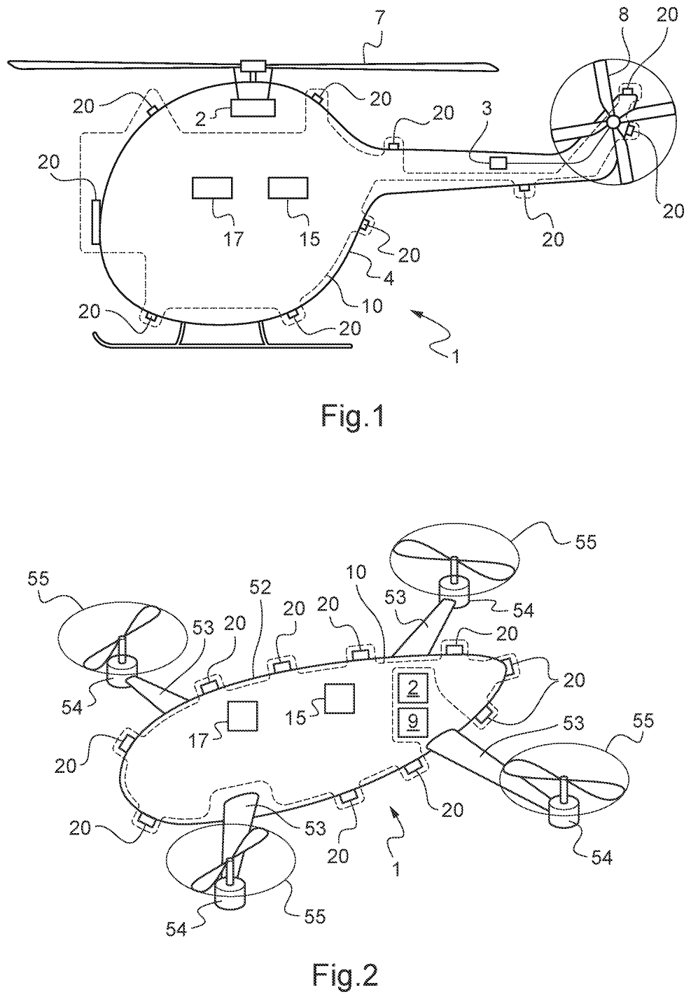

The aircraft 1 shown in FIG. 1 is a rotary wing aircraft comprising a fuselage 4, skid-type landing gear, a main rotor 7 arranged above the fuselage 4, an anti-torque rear rotor 8 arranged on a tail boom of the aircraft 1 and a system 10 for detecting and avoiding obstacles comprising at least three detection spaces. The aircraft 1 also comprises two control devices 2,3 for controlling the aircraft 1, namely a first control device 2 for modifying the pitch of the blades of the main rotor 7 and a second control device 3 for modifying the pitch of the blades of the anti-torque rear rotor 8. The detection and avoidance system 10 comprises at least a calculator 15, a plurality of sensors 20 for detecting obstacles and a control system 17 controlling the two control devices 2,3 in order to generate or modify the movement of the aircraft 1.

The control system 17 may comprise at least one manual control and at least one automatic control for the two control devices 2,3. Manual controls of the control system 17 are, for example, a lever for varying the collective pitch and a stick for controlling the cyclic pitch of the blades of the main rotor 7 linked to the first device for varying the pitch of the blades of the main rotor 7 and a rudder bar linked to the second device for varying the pitch of the blades of the anti-torque rear rotor 8. The automatic control is also linked to the two control devices 2,3 of the aircraft 1.

The aircraft 1 shown in FIG. 2 is an aircraft without an onboard pilot comprising, in particular, several lift rotors 55 and also referred to as a “multirotor drone”. This aircraft 1 comprises a central body 52, four connecting arms 53 connected to the central body 52 and four lift rotors 55 supported respectively by a connecting arm 53 and a control device 2 of the aircraft 1 controlling the pitch of the blades of each rotor 55 and/or the speed of rotation of each lift rotor 55 in order to generate or modify the movement of the aircraft 1. The lift rotors 55 are rotated by four separate motors 54 and provide propulsion and lift for the aircraft 1. The four motors 54 may be heat engines or indeed electric motors, for example. This drone aircraft 1 also comprises an autopilot 9 and a system 10 for detecting and avoiding obstacles equipped with a calculator 15, a plurality of sensors 20 and a control system 17 controlling the control device 2.

The aircraft 1, without an onboard pilot, may be controlled remotely or indeed automatically, via the autopilot 9.

For example, the calculator 15 may comprise at least one processor and at least one memory, at least one integrated circuit, at least one programmable system, and at least one logic circuit, these examples not limiting the scope given to the expression “calculator”. The calculator may be a calculator dedicated to carrying out the method or a shared calculator of the aircraft 1 having multiple functions.

However, the aircraft 1 may comprise a different number of rotors and motors or indeed be another type of aircraft comprising, for example, one or more fixed wings, without departing from the context of the disclosure.

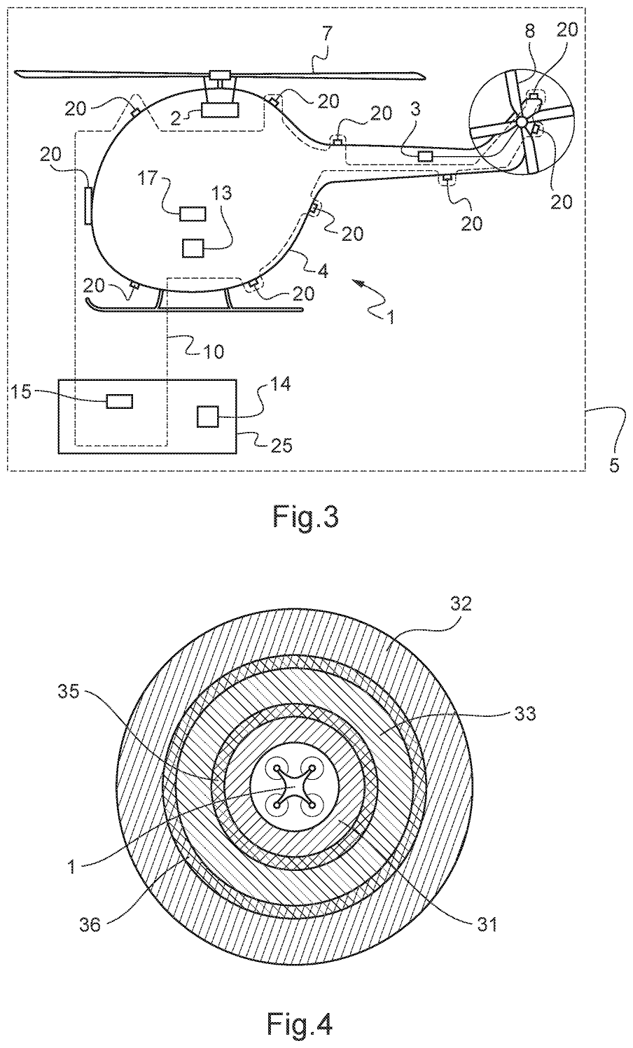

The assembly 5 for detecting and avoiding an obstacle shown in FIG. 3 comprises a remote control station 25 and an aircraft 1 as well as a system 10 for detecting and avoiding obstacles equipped with a calculator 15, a control system 17 and a plurality of sensors 20. The aircraft 1 comprises the plurality of sensors 20 and the control system 17 of the system 10 for detecting and avoiding obstacles as well as a first communication device 13. The control station 25 comprises the calculator 15 of the system 10 for detecting and avoiding obstacles and a second communication device 14.

In this case, the aircraft 1 comprises no onboard pilot, and a pilot may be located in the control station 25 in order to control the aircraft 1 remotely. The first communication device 13 then communicates with the second communication device 14 in order in particular to exchange navigation data between the control station 25 and the aircraft 1.

Moreover, the first communication device 13 communicates with the second communication device 14 in order to transmit information collected by the plurality of sensors 20 to the calculator 15.

In all cases, the system 10 for detecting and avoiding obstacles is configured to implement a method for detecting and avoiding obstacles comprising at least three detection spaces 31-33 and intended for an aircraft 1. This method for detecting and avoiding obstacles makes it possible firstly to detect at least one obstacle in at least one of the detection spaces 31-33 and secondly to determine and carry out an avoidance maneuver.

Moreover, regardless of the type of aircraft 1, the plurality of sensors 20 comprises at least three series of sensors, each series of sensors 20 being associated with a detection space 31-33, each detection space 31-33 being covered by at least one series of sensors 20. Each series of sensors 20 may comprise electromagnetic, optical or indeed acoustic sensors. The sensors 20 of each series of sensors are distributed in a substantially uniform manner over the aircraft 1 in order to allow detection in the entirety of the detection space 31-33 associated with this series of sensors.

Each detection space 31-33 may, for example, cover a shape falling substantially between two spheres. FIG. 4 shows three detection spaces 31-33 according to this configuration around the aircraft 1, seen from above. A first detection space 31 is the detection space closest to the aircraft 1, a second detection space 32 is the detection space furthest from the aircraft 1, and a third detection space 33 is situated between the first detection space 31 and the second detection space 32.

Moreover, two adjacent detection spaces 31-33 have an overlap zone 35-36 situated at the periphery of each of these three detection spaces 31-33 and constituting a common detection zone between two detection spaces 31-33. The overlap zones 35-36 thus ensure spatial continuity and a transition between the detection spaces 31-33. In this way, an obstacle may be detected in all the detection spaces 31-33 continuously, in particular without a non-detection zone between the detection spaces 31-33.

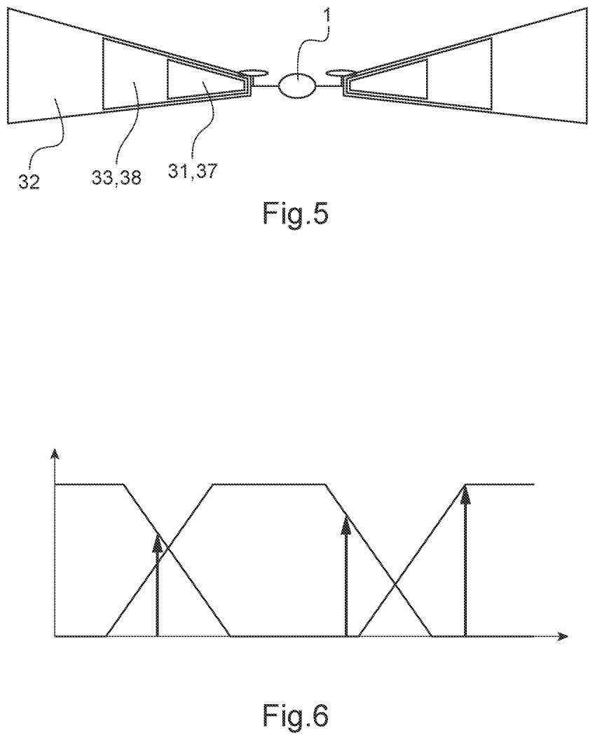

Each detection space 31-33 may also cover a zone of 360 degrees (360°) horizontally around the aircraft 1 and a sector of a few tens of degrees vertically, for example 20°. FIG. 5 shows three detection spaces 31-33 according to this configuration around the aircraft 1, in front view. The first detection space 31 is the detection space closest to the aircraft 1, the second detection space 32 is the detection space furthest from the aircraft 1, and the third detection space 33 is situated between the first detection space 31 and the second detection space 32.

According to this example, an overlap zone 37,38 in which two detection spaces 31-33 overlap comprises one of these two detection spaces 31-33. Thus, the third detection space 33 comprises the first detection space 31 constituting, as such, the overlap zone 37. Similarly, the second detection space 32 comprises the first detection space 31 and the third detection space 33, the third detection space 33 constituting the overlap zone 38.

Moreover, each series of sensors 20 advantageously comprises sensors for detection ranges optimized for the detection space 31-33 covered. Thus, each series of sensors 20 makes it possible to accurately and effectively detect the presence of an obstacle in the associated detection space 31-33.

The first detection space 31 is covered by short-range sensors 20, for example cameras associated with active vision processing, ultrasound sensors or infrared sensors. Active vision processing concerns, for example, imaging with temporal aliasing or indeed image reconstruction using point clouds or sets. The first detection space 31 covers, for example, a zone of between 10 and 30 meters around a small aircraft 1, typically with a wingspan of between one and a few meters.

The second detection space 32 may be covered by long-range sensors 20, for example RADAR sensors and/or cameras. The second detection space 32 covers, for example, a zone of between 100 and 300 meters around this small aircraft 1.

The third detection space 33 may be covered by mid-range sensors 20, for example stereoscopic cameras, LEDDAR sensors and/or LIDAR sensors or indeed ultrasound sensors or infrared sensors. The third detection space 33 covers, for example, a zone of between 20 and 150 meters around this small aircraft 1.

The method for detecting and avoiding obstacles according to the disclosure comprises the following steps.

Firstly, a step of detecting at least one obstacle in the environment of the aircraft 1, i.e., in the detection spaces 31-33, is carried out. This step of detecting at least one obstacle is carried out by means of the series of sensors 20. Thus, an obstacle may be detected in at least one detection space 31-33 by one series of sensors 20. Moreover, each series of sensors 20 may comprise at least two different types of sensor technologies covering the same detection space 31-33. In this case, the information provided by these at least two sensor technologies 20 may be merged in order to improve the detection of the obstacle and the accuracy of this detection. Similarly, when an obstacle can be detected in an overlap zone 35-38 where two detection spaces 31-33 overlap, the information provided by the series of sensors 20 associated with each of these two detection spaces 31-33 may also be merged.

Moreover, several obstacles may be detected simultaneously in the same detection space 31-33 or indeed in several detection spaces 31-33.

Next, a step of analyzing at least one detected obstacle in one of the detection spaces 31-33 is carried out in order to determine at least one characteristic of each detected obstacle. This step of analyzing at least one obstacle is carried out by means of the calculator 15 and the information provided by at least one series of sensors 20. If a detected obstacle is situated in an overlap zone 35-38, the information provided by at least two series of sensors 20 is used. The same applies if several obstacles are detected in at least two different detection spaces 31-33.

During this step of analyzing at least one detected obstacle, at least one characteristic of this at least one detected obstacle is defined. The characteristics of an obstacle comprise, for example, the relative position of the obstacle with respect to the aircraft and it dimensions, as well as the speed, course and trajectory of this at least one detected obstacle with respect to the aircraft and/or the time before a possible impact, TBI. These latter characteristics may be determined or estimated, for example, from the positions of the detected obstacle with respect to the aircraft 1 measured over a more or less long period of time depending on the accuracy of the information provided by the one or more series of sensors 20.

The characteristics of an obstacle may also comprise the type of obstacle identified by means of the calculator 15 depending on the information provided by the sensors 20 according to a learning process. To this end, the analysis step may comprise a sub-step of identifying a type of obstacle to which each detected obstacle may correspond.

The identification of the type of obstacle corresponding to each detected obstacle requires information provided by the sensors 20 that is sufficiently accurate to be able to distinguish, for example, distinctive shapes of the detected obstacle and/or dimensions that can be compared with types of obstacles previously identified and stored in a database. This sufficiently accurate information may be provided by ultrasound or infrared sensors, LEDDAR or LIDAR sensors or indeed cameras, optionally stereoscopic cameras. This information, for example the images in the case of cameras, is analyzed by known pattern analysis and recognition methods implemented by the calculator 15. The database may be stored in a memory included in the calculator 15 or indeed in a memory included in the aircraft 1 and connected to the calculator 15.

The identification sub-step may, in particular, implement known pattern analysis and recognition methods applied to the information provided by the sensors 20. Next, shapes associated with each detected obstacle may be compared with the information in the database of obstacle types. This database of obstacle types may be constructed by learning carried out in advance on a large number of known and potential obstacle types. Known types of stationary obstacles are, for example, a wall, a building, a tree, an aircraft in hovering flight, etc. Known types of mobile obstacles are, for example, a tree leaf, a balloon, a bird or indeed an aircraft in forward flight.

Furthermore, the analysis step may comprise a sub-step of determining a weighting associated with each detected obstacle in order to determine a weighting associated with each detected obstacle. This weighting is expressed, for example, by a weighting coefficient.

This weighting associated with a detected obstacle may, for example, depend on the detection space in which this obstacle is detected and/or the characteristics of the detected obstacle.

This weighting associated with a detected obstacle may also depend on criteria related to the aircraft such as, for example, the maneuverability of the aircraft, its maximum achievable acceleration and speed, its dimensions, its impact resistance, characterized, for example, by the bird-strike test, and its structural strength, characterized in particular by a load factor.

This weighting associated with a detected obstacle may be defined, for example, using artificial intelligence.

A deep learning process making it possible to define the type of obstacle corresponding to the detected obstacle may also determine the weighting associated with each detected obstacle, depending, for example, on the characteristics and criteria mentioned above.

A fuzzy logic method may also be used to determine the value of the weighting associated with each detected obstacle. A matrix of rules linking membership domains of the characteristics and criteria mentioned above may also be used in this fuzzy logic method. Moreover, a value of the weighting associated with a detected obstacle may change over time and also as the obstacle approaches or moves away from the aircraft.

The fuzzy logic method may in particular use three membership domains for each characteristic or criterion involved in determining the weighting of an obstacle. FIG. 6 shows a graph comprising these three membership domains for a criterion, corresponding to a low value, a medium value and a high value of this criterion. The membership domains shown are trapezoidal, but other shapes are possible for these membership domains. Similarly, the number de membership domains associated with a characteristic or a criterion may be different.

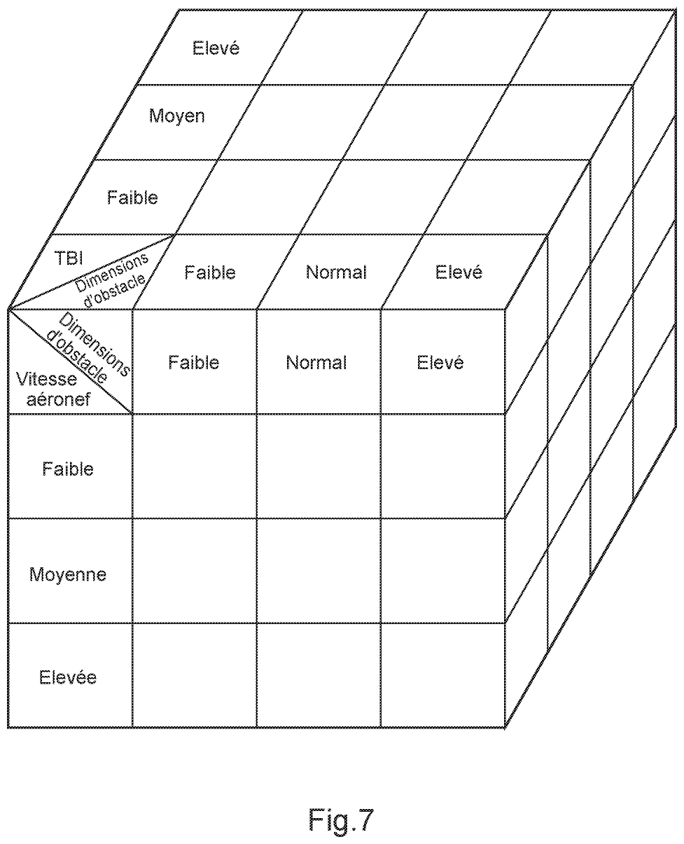

The criteria that allow the weighting to be determined may then be combined with each other, for example according to a decision matrix, in order to define a weighting coefficient associated with the detected obstacle. Such a decision matrix is shown in FIG. 7, the decision matrix shown involving three criteria and representing a cube. Each square of the decision matrix is, for example, associated with a weighting coefficient.

The three membership domains mentioned above are included in the decision matrix for three criteria, for example the time TBI, the speed of the obstacle and the dimensions of the obstacle, possibly associated with the type of obstacle corresponding to this detected obstacle.

Such a fuzzy logic method may also be used to provide an alert concerning the necessity or not of performing an avoidance maneuver and to provide, if required, characteristics of a deviation from the current trajectory of the aircraft, for example the value and the orientation of this deviation, in order to avoid the detected obstacle.

Such a fuzzy logic method may also be used in order to determine several avoidance trajectories or several avoidance commands during the step of determining at least one avoidance trajectory or one avoidance command, these avoidance trajectories or these avoidance commands forming, for example, a particle swarm of trajectories or commands.

Next, a step of determining at least one avoidance trajectory or one avoidance command is carried out by means of the calculator 15. Each avoidance trajectory or each avoidance command is determined in order for the aircraft 1 to avoid each detected obstacle, taking into account the determined or estimated characteristics of each detected obstacle, while complying with the structural limits of the aircraft 1 and constraints related to ensuring the comfort of the passengers in the aircraft 1 or indeed the integrity of the transported payload.

This step of determining at least one avoidance trajectory or one avoidance command may be carried out only when a risk of collision with a detected obstacle is established. Such a risk of collision is established, for example, when the current trajectory of the aircraft interferes with or passes in the vicinity of the detected obstacle, or indeed its estimated trajectory. The aircraft is considered to be passing in the vicinity of the detected obstacle or its trajectory if the minimum distance between the current trajectory of the aircraft and the detected obstacle or its estimated trajectory is less than a distance threshold. In order to estimate this risk of collision, the analysis step may comprise a sub-step of estimating this risk of the aircraft colliding with a detected obstacle.

An avoidance trajectory may comprise a deviation from a current trajectory of the aircraft in order to first avoid an obstacle and then return to this current trajectory in order to reach the initial objective. An avoidance trajectory may also consist of a new trajectory replacing the current trajectory of the aircraft in order to avoid, for example, one or more obstacles and then safely reach its initial objective.

An avoidance command may, for example, comprise a change in the forward speed, acceleration or indeed load factor of the aircraft without the aircraft leaving the course initially provided towards the initial objective.

An avoidance trajectory or an avoidance command may be determined in a known manner by using, for example, one or more suitable algorithms.

Furthermore, the weighting associated with each detection space and/or each detected obstacle may also be taken into account during the step of determining at least one avoidance trajectory or one avoidance command.

For example, an algorithm may simultaneously take into account this weighting associated with each detected obstacle and the characteristics of each detected obstacle so as to determine at least one avoidance trajectory or one avoidance command in order to avoid each detected obstacle.

Thus, during the step of determining at least one avoidance trajectory or one avoidance command, one or more intermediate avoidance trajectories or one or more intermediate avoidance commands may be determined independently for each detection space by taking into account each obstacle detected in this detection space. A weighting relative to each detection space is then associated with each intermediate avoidance trajectory or with each intermediate avoidance command corresponding to a detection space. Finally, the intermediate avoidance trajectories or the intermediate avoidance commands relative to these detection spaces are combined, taking into account these weightings in order to determine one or more avoidance trajectories or one or more avoidance commands.

During the step of determining at least one avoidance trajectory or one avoidance command, one or more intermediate avoidance trajectories or one or more intermediate avoidance commands may also be determined independently for each detected obstacle. The weighting relative to each detected obstacle is then associated with each intermediate avoidance trajectory or with each intermediate avoidance command corresponding to a detected obstacle. Next, the intermediate avoidance trajectories or the intermediate avoidance commands relative to these detected obstacles are combined, taking into account these weightings in order to determine one or more avoidance trajectories or one or more avoidance commands.

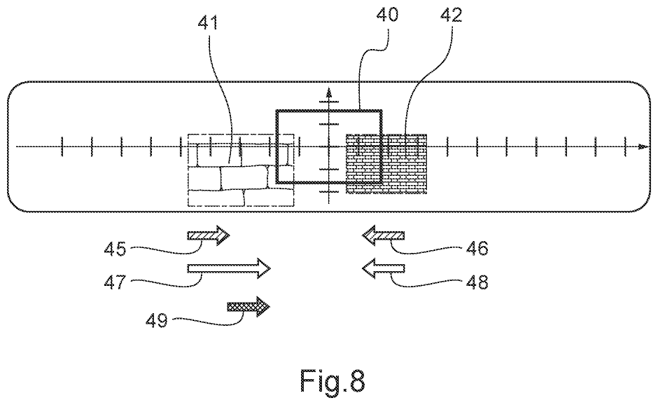

According to an example shown in FIG. 8, two obstacles 41,42 are detected in the detection spaces 31-33. A first obstacle is detected in the third detection space 33, for example 35 meters from the aircraft 1, and a second obstacle 42 is detected in the second detection space 32, for example 200 meters from the aircraft 1. It is noted that the two detected obstacles 41,42 are in the vicinity of the current trajectory of the aircraft 1 shown by the corridor 40 taking into account the distance threshold around this current trajectory. An avoidance trajectory or one or more avoidance commands must therefore be determined.

To this end, a first intermediate avoidance trajectory 45 is determined relative to the first detected obstacle 41. This first intermediate avoidance trajectory 45 comprises a shift to the right for the aircraft 1 in order for the first obstacle 41 to move out of the corridor 40. A second intermediate avoidance trajectory 46 is determined relative to the second obstacle 42. This second intermediate avoidance trajectory 46 comprises a shift to the left for the aircraft 1 in order for the second obstacle 42 to move out of the corridor 40.

Weightings relative to each detection space 31-33 are then associated with the detected obstacles 41,42 and with the intermediate avoidance trajectories 45,46, respectively forming weighted intermediate avoidance trajectories 47,48. For example, a weighting coefficient is used and multiplied by the distance of the shift of each of the intermediate avoidance trajectories 45,46, in order to obtain weighted intermediate avoidance trajectories 47,48. The weighting coefficient associated with the first obstacle 41 is greater than the weighting coefficient associated with the second obstacle 42, the first obstacle 41 being closer to the aircraft than the second obstacle 42.

For example, a first weighting coefficient corresponding to the third detection space 33 is equal to two and applied to the first intermediate avoidance trajectory 45, whereas a second weighting coefficient corresponding to the second detection space is equal to one and applied to the second intermediate avoidance trajectory 46.

Next, an avoidance trajectory 49 may be determined by combining the weighted intermediate avoidance trajectories 47,48, for example by merging these weighted intermediate avoidance trajectories 47,48. The determined avoidance trajectory 49 is then a shift to the right for the aircraft 1 in order to first avoid the first obstacle 41.

Next, once the first obstacle 41 no longer represents a danger for the aircraft 1, a new avoidance trajectory is determined in order to avoid the second obstacle 42. This avoidance trajectory is, for example, a shift to the right or to the left for the aircraft 1, depending on the position of this second obstacle 42 with respect to the corridor 40.

Similar reasoning can be applied to combine intermediate avoidance commands.

Thus, each avoidance trajectory or each avoidance command may advantageously be determined in order to minimize the changes in the trajectory or control of the aircraft 1 and, therefore, to limit the in-flight stresses experienced by the aircraft 1 and its payload, and to limit energy consumption.

A single avoidance trajectory or a single avoidance command may be determined during the step of determining at least one avoidance trajectory or one avoidance command.

However, when several avoidance trajectories or several avoidance commands are determined during the step of determining at least one avoidance trajectory or one avoidance command, the method according to the disclosure may comprise an additional step of choosing an effective avoidance trajectory or an effective avoidance command respectively from these determined avoidance trajectories or these determined avoidance commands. This choice of an effective avoidance trajectory or an effective avoidance command from the determined avoidance trajectories or the determined avoidance commands may be made by minimizing, for example, one or more criteria such as the energy consumption of the aircraft, the flight time, the distance travelled, etc.

Next, a step of controlling the control system 17 of the aircraft 1 is carried out. The calculator transmits the characteristics of the determined avoidance trajectory or the determined avoidance command or, if applicable, the effective avoidance trajectory or the effective avoidance command, to the control system 17 of the aircraft 1. The control system 17 then transmits instructions to the control devices 2,3 of the aircraft 1 in order for the aircraft 1 to automatically carry out the avoidance maneuver according to the avoidance trajectory or the avoidance command or, if applicable, the effective avoidance trajectory or the effective avoidance command, so as to avoid each detected obstacle.

Moreover, the use of several detection spaces 31-33 makes it possible to detect an obstacle as early as possible, in particular when it enters the second detection space 32. The distance between the detected obstacle and the aircraft 1 may then be considerable. Therefore, it may be premature at this point in time to engage a maneuver to avoid the detected obstacle, since the latter may still change trajectory and, therefore, never come dangerously close to the aircraft 1.

Thus, if at least one obstacle is detected in the second detection space 2, the step of determining at least one avoidance trajectory or one avoidance command and the step of controlling the control system 17 can be inhibited. The method according to the disclosure may then comprise an additional step of monitoring said at least one obstacle. This additional monitoring step may be carried out by means of at least one series of sensors 20. When this obstacle or another obstacle enters the third detection space 33, the additional monitoring step is stopped and the steps of determining at least one avoidance trajectory or one avoidance command and of controlling the control system 17 are carried out again.

The TBI relative to this detected obstacle in the second detection space 32 may also be taken into account before inhibiting these steps and optionally carrying out the additional monitoring step. For example, the steps of determining at least one avoidance trajectory or one avoidance command and of controlling the control system 17 may be inhibited and the additional monitoring step may be carried out when the TBI is greater than a first time threshold.

Conversely, when the TBI associated with a detected obstacle is very short, typically less than a second time threshold, during the analysis step, and regardless of the detection space 31-33 in which this obstacle is located, the step of determining at least one avoidance trajectory or one avoidance command may be inhibited and an avoidance trajectory or an avoidance command is chosen respectively from predetermined emergency avoidance trajectories or predetermined emergency avoidance commands. Thus, the step of controlling the control system is carried out immediately in order for the emergency avoidance maneuver to be carried out quickly so as to avoid the detected obstacle. The predetermined emergency avoidance trajectories or the predetermined emergency avoidance commands may be stored, for example, in a memory connected to the calculator 15.

Moreover, when an obstacle is detected in the first detection space 31, the step of analyzing the detected obstacle and the step of determining at least one avoidance trajectory or one avoidance command may also be inhibited. The avoidance trajectory or the avoidance command to be carried out is then chosen from the predetermined emergency avoidance trajectories or the predetermined emergency avoidance commands. Indeed, since the detected obstacle is then close to the aircraft 1, it is necessary to react quickly in order for the aircraft 1 to move away from the detected object. In order to carry out this emergency avoidance maneuver as quickly as possible, the step of analyzing the detected obstacle and the step of determining at least one avoidance trajectory or one avoidance command are not carried out.

The step of choosing an avoidance trajectory or an avoidance command is carried out by choosing the avoidance trajectory or the avoidance command respectively from the predetermined emergency avoidance trajectories or the predetermined emergency avoidance commands by means of the calculator 15.

Each predetermined emergency avoidance trajectory or each predetermined emergency avoidance command allows a rapid change for the aircraft 1 while complying with the structural limits of the aircraft 1. The undertaking of this effective emergency avoidance trajectory or this emergency avoidance command is in this case similar to a reflex action.

For example, this emergency avoidance maneuver comprises a quick movement upwards, to the right or to the left for the aircraft 1. For example, if the obstacle is detected to the right of the aircraft 1, the emergency avoidance trajectory chosen is a quick movement to the left for the aircraft.

By inhibiting these different steps when an obstacle is detected in the first or second detection space 31,32, the method according to the disclosure behaves substantially like a brain, and the three detection spaces 31-33 each correspond to a given reaction mode.

The second detection space 32 is the circle based on long-term thinking and is comparable to the functioning of the frontal cortex with its capacity for situation analysis and long-term thinking. The second detection space 32 allows an obstacle to be detected as early as possible, even if it is not yet recognized and identified.

The third detection space 33 is the circle based on short-term thinking and is comparable to the functioning of the visual or auditory cortex. The third detection space 33 must at least make it possible to characterize the detected obstacle, or indeed to identify it.

The first detection space 31 is the reptilian circle and is comparable to the amygdala and its reflex reactions. The first detection space 31 makes the aircraft 1 react within the limits of its mechanical and avionic strength and within the load limits acceptable to the payload.

Naturally, the present disclosure is subject to numerous variations as regards its implementation. Although several implementations are described above, it should readily be understood that an exhaustive identification of all possible embodiments is not conceivable. It is naturally possible to replace any of the means described with equivalent means without going beyond the ambit of the present disclosure.

What is claimed is:

1. A method for detecting and avoiding obstacles with several obstacle detection spaces for an aircraft, the aircraft comprising:
a control system of the aircraft;
a plurality of sensors for detecting obstacles, the plurality of sensors comprising at least three series of sensors; and
at least one calculator;
wherein the method comprises the following steps:
detecting at least one obstacle present in at least one of at least three detection spaces, the at least three detection spaces comprising a first detection space, a second detection space and at least one third detection space, the first detection space being the detection space closest to the aircraft, the second detection space being the detection space furthest from the aircraft, each of the at least three series of sensors being associated with at least one detection space, each detection space being covered by at least one series of sensors;
analyzing the detected obstacle(s) in at least one of the detection spaces by means of the calculator in order to determine at least one characteristic of the obstacle(s), the analysis step comprising:
a sub-step of determining a weighting associated with each detected obstacle using a fuzzy logic method and a decision matrix in order to determine a weighting associated with each detected obstacle;
determining at least one avoidance trajectory or one avoidance command enabling the aircraft to avoid the detected obstacle(s) depending on at least one characteristic of the obstacle by means of the calculator; and
controlling the control system in order for the aircraft to automatically undertake an avoidance trajectory or an avoidance command.

2. The method according to claim 1
wherein, when at least two avoidance trajectories or at least two avoidance commands are determined during the step of determining at least one avoidance trajectory or one avoidance command, the method comprises an additional step of choosing an effective avoidance trajectory or an effective avoidance command respectively from the at least two determined avoidance trajectories or the at least two avoidance commands and the step of controlling the control system is carried out using the chosen effective avoidance trajectory or the chosen effective avoidance command.

3. The method according to claim 2
wherein the effective avoidance trajectory or the avoidance command is chosen respectively from the at least two determined avoidance trajectories or the at least two avoidance commands by minimizing one or more criteria chosen from the energy consumption of the aircraft, a flight time on the avoidance trajectory or the avoidance command, and a distance travelled along the avoidance trajectory.

4. The method according to claim 1
wherein at least two detection spaces have a common detection zone, thus ensuring continuity between the detection spaces and avoiding the presence of non-detection zones.

5. The method according to claim 4
wherein the common detection zone of two detection spaces is one of the two detection spaces ensuring detection redundancy in the common detection zone.

6. The method according to claim 1
wherein, during the analysis step, the characteristic(s) of the obstacle(s) comprise(s) a relative position of the obstacle with respect to the aircraft, a relative course of the obstacle with respect to the aircraft, a relative speed of the obstacle with respect to the aircraft, a relative trajectory of the obstacle with respect to the aircraft, dimensions of the obstacle, a mass of the obstacle, a time before impact between the obstacle and the aircraft, and a type of the obstacle.

7. The method according to claim 1
wherein the weighting associated with a detected obstacle is defined depending on:
the detection space in which the obstacle has been detected;
the dimensions of the obstacle;
the mass and the speed of the obstacle; and
the relative trajectory of the obstacle with respect to the aircraft;
the type of the obstacle; and/or
the time before impact, TBI.

8. The method according to claim 7
wherein the weighting associated with a detected obstacle is defined depending on the maneuverability of the aircraft, its trajectory, its maximum speed, its size, its resistance to bird-strike impact and its load factor.

9. The method according to claim 1
wherein the step of determining at least one avoidance trajectory or one avoidance command uses a fuzzy logic method and a decision matrix.

10. The method according to claim 1
wherein, during the step of determining at least one avoidance trajectory or one avoidance command, one or more intermediate avoidance trajectories or intermediate avoidance commands are determined independently for each detection space, taking into account each detected obstacle in each detection space, and/or for each detected obstacle, and the intermediate avoidance trajectories or intermediate avoidance commands are then combined by taking into account the weightings relative to each detection space and/or each detected obstacle in order to determine at least one avoidance trajectory or one avoidance command.

11. The method according to claim 1
wherein the analysis step comprises a sub-step of identifying a type of obstacle to which the detected obstacle(s) may correspond.

12. The method according to claim 1
wherein the analysis step comprises a sub-step of estimating a risk of the aircraft colliding with at least one detected obstacle and the step of determining at least one avoidance trajectory or one avoidance command and the step of controlling the control system are carried out if the risk of the aircraft colliding with a detected obstacle is established.

13. The method according to claim 1
wherein, if at least one obstacle is detected in the second detection space, the step of determining at least one avoidance trajectory or one avoidance command and the step of controlling the control system are inhibited.

14. The method according to claim 1
wherein, if at least one obstacle is detected in the second detection space and the step of analyzing the detected obstacle determines a time before a possible impact greater than a first time threshold, the step of determining at least one avoidance trajectory or one avoidance command and the step of controlling the control system are inhibited.

15. The method according to claim 1
wherein, if an obstacle is detected in the first detection space, the step of analyzing the detected obstacle and the step of determining at least one avoidance trajectory or one avoidance command are inhibited and the avoidance trajectory or the avoidance command is chosen respectively from predetermined emergency avoidance trajectories or predetermined emergency avoidance commands.

16. The method according to claim 1
wherein, if at least one obstacle is detected in one of the detection spaces and the step of analyzing the detected obstacle determines a time before a possible impact less than a second time threshold, the step of determining at least one predetermined emergency avoidance trajectory or one avoidance command is inhibited and a predetermined emergency avoidance trajectory or an avoidance command is chosen respectively from predetermined emergency avoidance trajectories or predetermined emergency avoidance commands.

17. The method according to claim 1
wherein each detection space has a substantially spherical shape around the aircraft and centered on the aircraft, or is at least a circle in a horizontal plane, or indeed is limited angularly in vertical planes of the aircraft.

18. A system for detecting and avoiding obstacles with several obstacle detection spaces for an aircraft, the system for detecting and avoiding obstacles comprising:
a control system of the aircraft;
a plurality of sensors for detecting obstacles; and
at least one calculator;
wherein the system for detecting and avoiding obstacles is configured to implement the method according to claim 1, the plurality of sensors comprises at least three series of sensors, at least one of the series of sensors covering a specific detection space in the environment of the aircraft.

19. An aircraft
wherein the aircraft comprises the system for detecting and avoiding obstacles with several obstacle detection spaces for the aircraft according to claim 18.

20. An assembly for detecting and avoiding an obstacle comprising the system for detecting and avoiding obstacles with several obstacle detection spaces and the aircraft and a control station;
wherein the system for detecting and avoiding obstacles with several obstacle detection spaces is according to claim 18, the aircraft comprising the control system and the plurality of sensors for detecting obstacles, and the control station comprising the calculator, the calculator controlling the control system of the aircraft remotely.
